(19) United States
(12) Patent Application Publication
(10) Pub. No.: US 2014/0051266 A1
(43) Pub. Date: Feb. 20, 2014

(54) ROTARY CONNECTOR

(71) Applicant: ALPS ELECTRIC CO., LTD., Tokyo (JP)

(72) Inventors: Keisuke AIKAWA, Tokyo (JP); Toshiaki ASAKURA, Tokyo (JP); Seishi TAKAHASHI, Tokyo (JP)

(73) Assignee: ALPS ELECTRIC CO., LTD., Tokyo (JP)

(21) Appl. No.: 13/951,016

(22) Filed: Jul. 25, 2013

(30) Foreign Application Priority Data
Aug. 20, 2012 (JP) 2012-181618

(51) Int. Cl. B60R 16/027

(52) U.S. Cl. CPC B60R 16/027
USPC 439/13

(57) ABSTRACT

In a rotary connector in which a movable body rotating with rotation and revolution of a planetary gear and a flat cable having a reversed portion are housed within a housing space defined between outer and inner cylindrical bodies, restricting walls extending in the circumferential direction with an opening therebetween are erected on the movable body molded of resin, the reversed portion is passed through the opening, and the radial movement of the flat cable is restricted. A plurality of groove portions are formed in the inner peripheral surfaces of the restricting walls so as to be continuous with one another along the circumferential direction, and the depth d of the groove portions and the central angle θ corresponding to the length in the circumferential direction of the groove portions are set within ranges of 0.5 mm≦d≦2.0 mm and 5 degrees≦θ≦30 degrees.

### CLAIM OF PRIORITY

This application contains subject matter related to and claims the benefit of Japanese Patent Application No. 2012-181618 filed on Aug. 20, 2012, the entire contents of which is incorporated herein by reference.

### BACKGROUND OF THE DISCLOSURE

1. Field of the Disclosure

The present disclosure relates to a rotary connector that is incorporated in an automotive steering system and is used as electrical connecting means for an airbag system or the like, and more specifically, to a rotary connector in which a flat cable is wound within a housing space between a stationary-side housing and a movable-side housing in a state where the winding direction of the flat cable is reversed via a reversed portion.

2. Description of the Related Art

A rotary connector includes a stationary-side housing having an outer cylindrical body and a movable-side housing having an inner cylindrical body, the stationary-side housing and the movable-side housing being disposed rotatably and concentrically, and a flat cable housed and wound within a housing space defined between the outer cylindrical body and the inner cylindrical body, and is used as electrical connecting means for an airbag inflator or the like mounted in a steering wheel having a limited number of rotations such as an automotive steering system. The flat cable is a belt-like member including an insulating film and conductors supported thereon. Two types of rotary connectors are known. One is wound in a spiral form, and the other is wound in a halfway reversed form. The latter, i.e., the reversed type rotary connector, can be made substantially shorter than the former. Therefore, the reversed type rotary connector is widely used.

Conventional rotary connectors include a reversed-type rotary connector in which a roller holder formed by erecting a guide wall and a plurality of support shafts on a ring-like rotating plate is rotatably disposed within a housing space, rollers are rotatably attached to the support shafts of the roller holder, and a reversed portion of a flat cable is passed through an opening between the guide wall and one of the rollers facing it as is described in, for example, Japanese Unexamined Patent Application Publication No. 2006-86043. In the rotary connector having such a configuration, when the movable-side housing rotates relative to the stationary-side housing in the forward or reverse direction, according to the rotation direction the flat cable is withdrawn from the outer cylindrical body and wound on the inner cylindrical body, or the flat cable is withdrawn from the inner cylindrical body and rewound on the outer cylindrical body. At that time, the reversed portion of the flat cable moves in the same direction by an amount of rotation smaller than that of the movable-side housing. Along with the reversed portion, the roller holder also moves in the same direction. The flat cable is withdrawn by a length about twice the amount of movement of them from the outer cylindrical body or the inner cylindrical body. That is, the roller holder is subjected to driving force (pulling force or pushing force) from the reversed portion of the flat cable, and rotates within the housing space. The radial movement of the flat cable is restricted by the plurality of rollers provided in the roller holder. Therefore, the flat cable is smoothly withdrawn from the outer cylindrical body and wound on the inner cylindrical body, or withdrawn from the inner cylindrical body and rewound on the outer cylindrical body.

Conventional rotary connectors also include, instead of a roller holder, a movable body rotatably supporting a planetary gear is disposed within a housing space, and the movable body is rotated with the rotation (rotation and revolution) of the planetary gear at the same speed as a reversed portion of a flat cable as is described in, for example, Japanese Unexamined Patent Application Publication No. 8-280127. A plurality of rollers are rotatably supported on the upper side of the movable body, and the reversed portion of the flat cable is passed through an opening between any adjacent two of the rollers. The planetary gear is rotatably supported on the lower side of the movable body. The planetary gear meshes with both an internal gear provided in the stationary-side housing and a sun gear provided in the movable-side housing. In the rotary connector having such a configuration, when the movable-side housing rotates relative to the stationary-side housing, the planetary gear meshing with the internal gear and the sun gear rotates at a predetermined reduction ratio, therefore the movable body rotatably supporting the planetary gear rotates within the housing space, and the reversed portion of the flat cable moves within the housing space at the same speed as the opening of the movable body.

As described above, in the conventional rotary connector disclosed in Japanese Unexamined Patent Application Publication No. 2006-86043, the roller holder is subjected to driving force (pulling force or pushing force) from the reversed portion of the flat cable, and rotates within the housing space. Therefore, the flat cable passing through the opening is required to have adequate stiffness (tension strength corresponding to elasticity described later), and a flat cable having a thick insulating film and high stiffness needs to be used. In contrast, in the rotary connector disclosed in Japanese Unexamined Patent Application Publication No. 8-280127, the opening of the movable body and the reversed portion of the flat cable can be moved at the same speed and in the same direction within the housing space by appropriately setting the gear ratio between gears including the planetary gear, therefore the movable body does not require driving force from the reversed portion of the flat cable, and an inexpensive and less elastic flat cable having a thin insulating film can be used. However, since the radial movement of the flat cable is restricted by the plurality of rollers rotatably attached to the support shafts of the movable body, the number of components forming the movable body increases, the cost increases, and rattle is likely to be generated owing to the clearance between the rollers and the support shafts.

These and other drawbacks exist.

### SUMMARY OF THE DISCLOSURE

The present disclosure is made in view of the related art, and provides a rotary connector whose structure can be simplified, whose cost can be reduced, and in which the need for rollers can be eliminated, and the generation of noise can be suppressed.

In an various embodiments, a rotary connector includes a stationary-side housing having an outer cylindrical body, a movable-side housing having an inner cylindrical body facing the outer cylindrical body and disposed concentrically with the stationary-side housing, at least one flat cable housed within a housing space between the outer cylindrical body and the inner cylindrical body in a state where the winding direction of the at least one flat cable is reversed halfway, the at least one flat cable being fixed to the stationary-side housing at one end and to the movable-side housing at the other end, and a movable body rotatably disposed within the housing space and having at least one opening through which the reversed portion of the at least one flat cable passes. A planetary gear rotatably supported by the movable body meshes with an internal gear provided in the stationary-side housing and a sun gear provided in the movable-side housing. Restricting walls extending in the circumferential direction of the housing space with the at least one opening therebetween are erected on the movable body, and a plurality of groove portions are formed along the circumferential direction in the inner peripheral surfaces of the restricting walls facing the inner cylindrical body. The depth d of the groove portions and the central angle θ corresponding to the length in the circumferential direction of the groove portions, that is, the angle θ between straight lines connecting two valleys formed by any adjacent two of the groove portions and the center of the movable body, are set within ranges of 0.5 mm≦d≦2.0 mm and 5 degrees≦θ≦30 degrees.

In exemplary rotary connectors, a plurality of restricting walls extending in the circumferential direction with openings therebetween are erected on a movable body that rotates within the housing space with the rotation and revolution of the planetary gears, and the radial movement of the flat cables is restricted by passing the reversed portions through the openings. Therefore, the movable body can be integrally molded, the structure can be simplified, the cost can be reduced, the need for rollers can be eliminated, and the generation of noise can be suppressed. A plurality of groove portions are formed in the inner peripheral surfaces of the restricting walls facing the inner cylindrical body along the circumferential direction, and the depth and groove width (length in the circumferential direction) of the groove portions are set within the above ranges. Therefore, the friction coefficient between the inner peripheral surfaces of the restricting walls and the flat cables is reduced. Although less elastic flat cables are used, the flat cables can be smoothly withdrawn to the outer cylindrical body side.

The dimension d and the angle θ are set within ranges of 0.5 mm≦d≦2.0 mm and 5 degrees≦θ≦30 degrees. If the dimension d is smaller than 0.5 mm, the friction coefficient cannot be sufficiently reduced. If the dimension d is greater than 2.0 mm, the groove portions 4c are too deep, and a production problem of the difficulty of molding arises. If the angle θ is smaller than 5 degrees, the groove portions are too fine, and it is difficult to mold the movable body 4. If the angle θ is greater than 30 degrees, the groove portions are too coarse, and the friction coefficient cannot be sufficiently reduced.

The plurality of groove portions form a corrugated shape in which recesses and protrusions are alternately arranged in the circumferential direction of the restricting walls. In this case, the shape of the whole movable body is simplified.

The at least one flat cable may comprise a plurality of flat cables, the at least one opening may comprise a plurality of openings, and the reversed portions of the plurality of flat cables may separately pass through the plurality of openings. In this case, a rotary connector employing two or more flat cables can be made.

### BRIEF DESCRIPTION OF THE DRAWINGS

FIG. 1 is a sectional view showing a state where a rotary connector according to an exemplary embodiment of the present disclosure is incorporated in a steering system;

FIG. 2 is a perspective view of the rotary connector according to an exemplary embodiment of the present disclosure;

FIG. 3 is a vertical sectional view of the rotary connector according to an exemplary embodiment of the present disclosure;

FIG. 4 is an exploded perspective view of the rotary connector according to an exemplary embodiment of the present disclosure;

FIG. 5 is a horizontal sectional view showing the internal structure of the rotary connector according to an exemplary embodiment of the present disclosure;

FIG. 6 is an explanatory view showing the meshing state of planetary gears and each gear provided in the rotary connector according to an exemplary embodiment of the present disclosure;

FIG. 7 is a sectional perspective view taken along line VII-VII of FIG. 6 according to an exemplary embodiment of the present disclosure;

FIG. 8 is a perspective view of a movable body provided in the rotary connector according to an exemplary embodiment of the present disclosure; and

FIG. 9 is an explanatory view showing the relationship between the depth and groove width of groove portions provided in the movable body according to an exemplary embodiment of the present disclosure.

### DETAILED DESCRIPTION OF THE DISCLOSURE

The following description is intended to convey a thorough understanding of the embodiments described by providing a number of specific embodiments and details involving a rotary connector. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

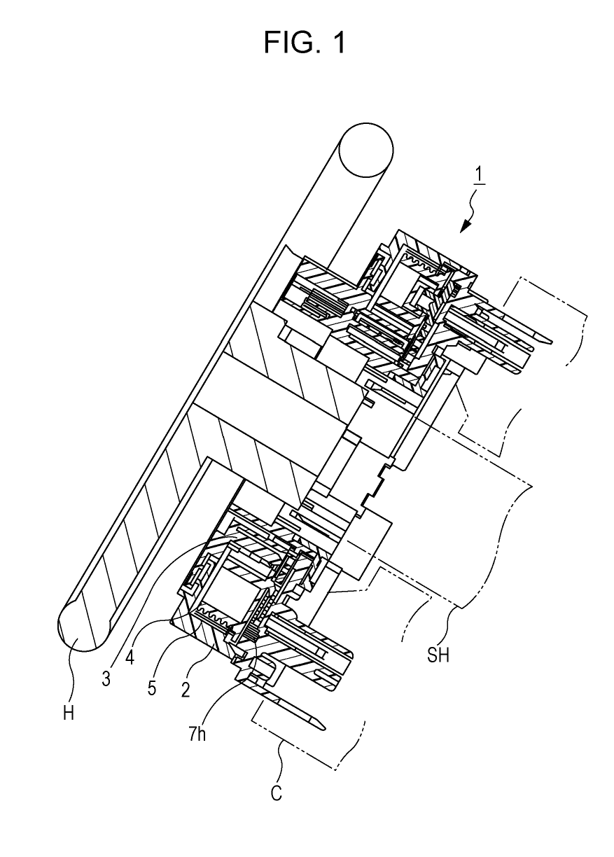

Various exemplary embodiments of the present disclosure will be described with reference to the drawings below. As shown in FIG. 1, a rotary connector 1 according to the exemplary embodiments may include a stationary-side housing 2, a movable-side housing 3, a movable body 4, and flat cables 5, and may be incorporated and used in an automotive steering system. The steering system may include, for example, a steering column C as an installation portion, a steering shaft SH protruding through the steering column C, and a steering wheel H connected to the distal end of the steering shaft SH. The steering wheel H is provided with an airbag inflator and various switches (not shown). The stationary-side housing 2 may be fixed to an attachment surface of the steering column C, and the steering wheel H may be fixed to the movable-side housing 3. The airbag inflator and others on the steering wheel H side and a control portion on the steering column C side may be connected to each other by the flat cables 5 of the rotary connector 1 regardless of the steering angle (rotation angle) of the steering wheel H. Since the steering shaft SH may be tilted at a predetermined tilt angle, the attachment surface of the steering column C may be tilted in such a manner that the lower end is closer to the driver's seat than the upper end, and therefore the rotary connector 1 may be incorporated and used in the steering system in a backward tilted position.

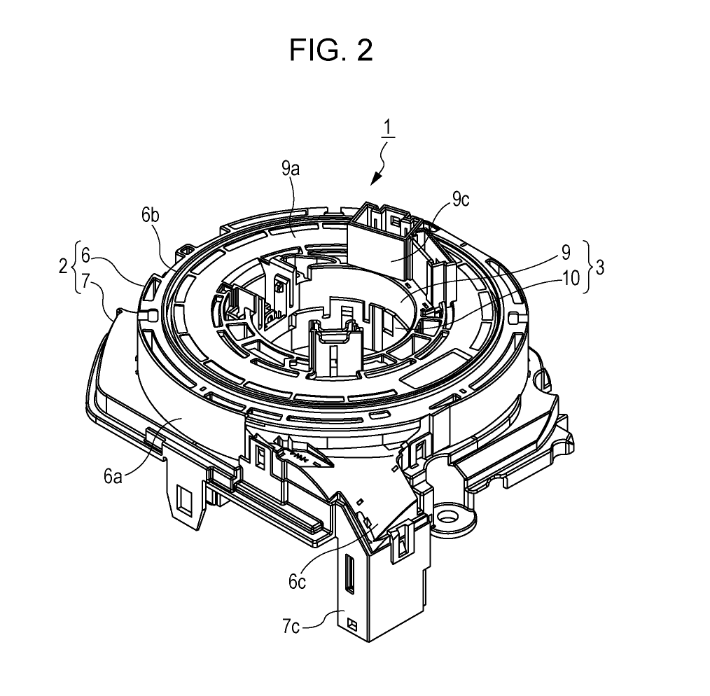

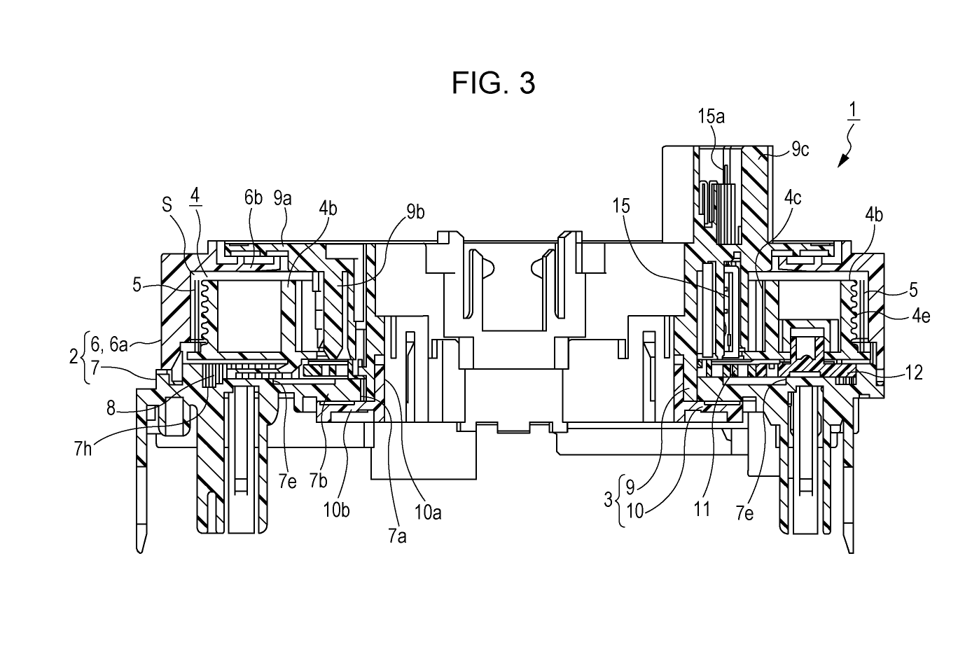

As shown in FIG. 2 to FIG. 7, the stationary-side housing 2 may include an upper case 6 and a lower case 7 made of synthetic resin, and the cases 6 and 7 may be connected and integrated by snap connection. The upper case 6 may include an outer cylindrical body 6a having a substantially truly circular inner peripheral surface, a ring portion 6b protruding inward from the upper end of the outer cylindrical body 6a, and a stationary-side connecting portion 6c protruding outward from the outer peripheral surface of the outer cylindrical body 6a. The outer cylindrical body 6a, the ring portion 6b, and the stationary-side connecting portion 6c may be integrally formed. Joint portions 15 (see FIGS. 3 to 5) for electrically connecting with the outer ends of the flat cables 5 as described later may be provided in a space formed by connecting the stationary-side connecting portion 6c and a connector cover 7c described later.

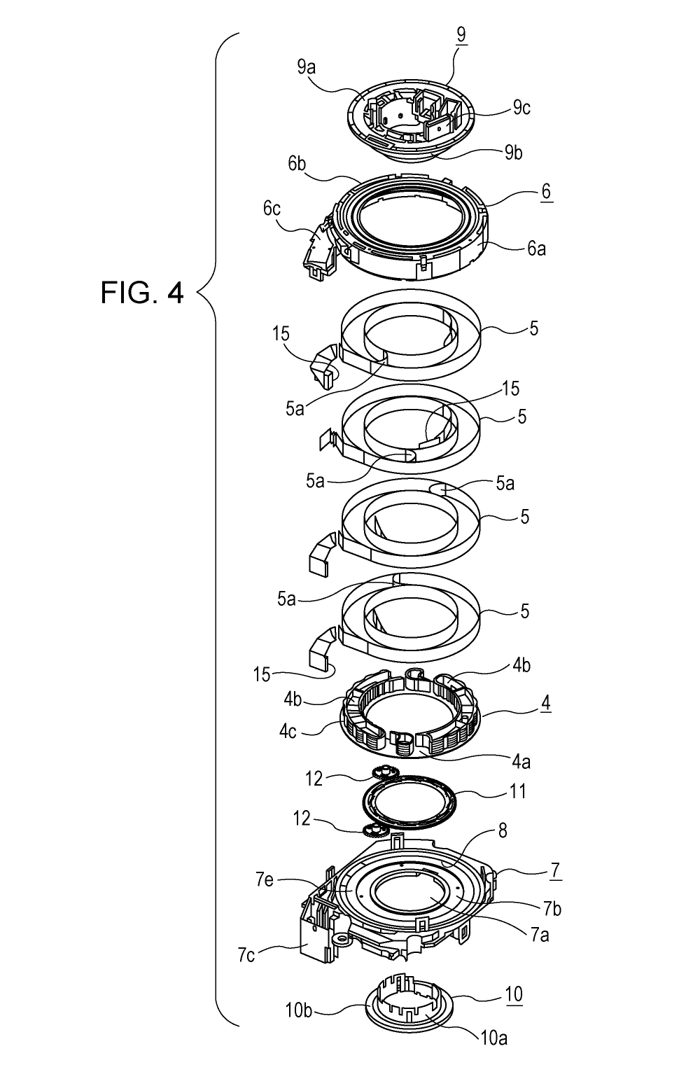

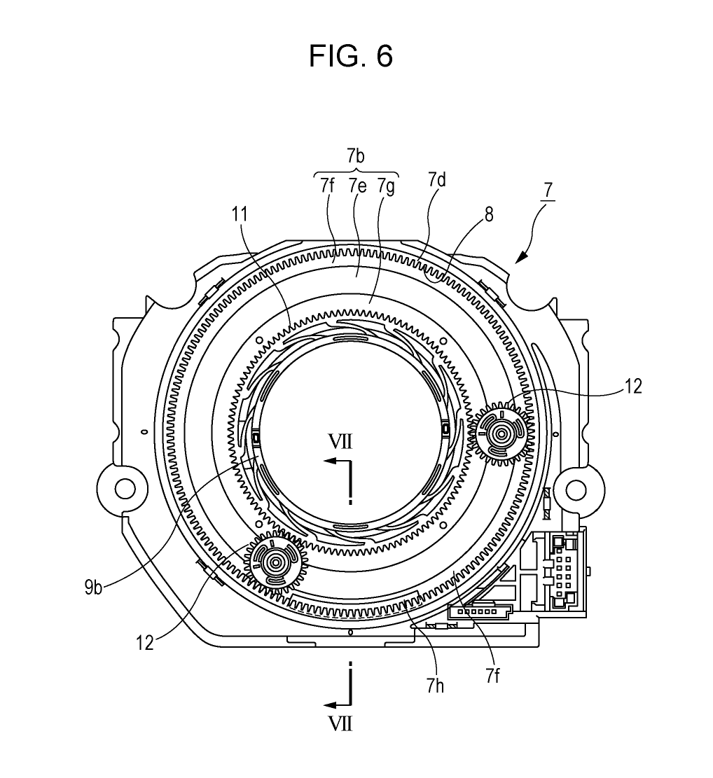

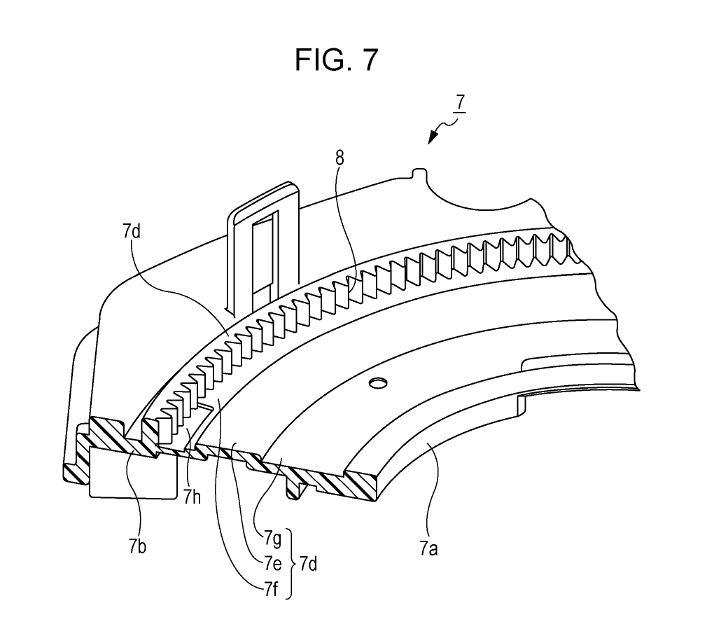

As shown in FIG. 4, the lower case 7 may include a bottom plate 7b having a center hole 7a, and a connector cover 7c protruding downward from a corner of the bottom plate 7b. When the upper case 6 and the lower case 7 are integrated, the stationary-side connecting portion 6c may be connected to the connector cover 7c (see FIG. 2). The lower case 7 has a stepped wall 7d that may protrude upward so as to surround the outer edge of the bottom plate 7b. This stepped wall 7d may be provided with an internal gear 8 (see FIG. 7). As shown in FIG. 6, the bottom plate 7b may include an annular protruding portion 7e formed on the radially inner side of the internal gear 8. The internal gear 8 and the annular protruding portion 7e may be formed concentrically with the center hole 7a. The region between the outer peripheral wall surface of the annular protruding portion 7e and the internal gear 8 may be a first annular groove 7f, in which a depressed portion 7h may be formed. As shown in FIG. 7, the radially outer inner wall of the depressed portion 7h may be located radially outward from the lower end of the internal gear 8. The first annular groove 7f and the depressed portion 7h form a recessed portion for accumulating foreign substances. The region between the inner peripheral wall surface of the annular protruding portion 7e and a sun gear 11 may be a second annular groove 7g (recessed portion). The annular protruding portion 7e may be located between the first annular groove 7f and the second annular groove 7g.

As shown in FIG. 3, the movable-side housing 3 may include an upper rotor 9 and a lower rotor 10 made of synthetic resin. The rotors 9 and 10 may be connected and integrated by snap connection. The upper rotor 9 may include a top plate portion 9a overlapping the ring portion 6b of the upper case 6, an inner cylindrical body 9b protruding downward from the outer peripheral edge of the top plate portion 9a, and a movable-side connecting portion 9c protruding upward from the upper surface of the top plate portion 9a. The top plate portion 9a, the inner cylindrical body 9b, and the movable-side connecting portion 9c may be integrally formed. In the movable-side connecting portion 9c, terminals 15a of joint portions 15 for electrically connecting the inner ends of the flat cables 5 with the steering wheel H side may be led out.

As shown in FIG. 3 and FIG. 4, the lower rotor 10 may include a connecting cylinder portion 10a into which the steering shaft SH may be inserted, and a ring-like flange portion 10b extending outward from the lower end of the connecting cylinder portion 10a. By inserting the connecting cylinder portion 10a into the center hole 7a from below and engaging the connecting cylinder portion 10a with the inner cylindrical body 9, the upper rotor 9 and the lower rotor 10 may be snap-connected. As a result, the top plate portion 9a of the upper rotor 9 may slidably face the upper surface of the ring portion 6b, and the flange portion 10b of the lower rotor 10 may slidably face the lower surface of the bottom plate 7b. Therefore, the movable-side housing 3 (the upper rotor 9 and the lower rotor 10) may be positionally restricted in the axial direction and rotatably connected to the stationary-side housing 2. In this state, the outer cylindrical body 6a and the inner cylindrical body 9b may face each other in the radial direction, and the ring portion 6b and the top plate portion 9a face the bottom plate 7b in the axial direction. By these members, a housing space S that houses the flat cables 5 may be defined between the housings 2 and 3 (see FIG. 3).

A sun gear 11 may be fixed to the lower end of the inner cylindrical body 9b of the upper rotor 9. As shown in FIG. 6, a pair of planetary gears 12 may mesh with the internal gear 8 provided in the lower case 7 and the sun gear 11. The internal gear 8 and the sun gear 11 may face each other with the annular protruding portion 7e of the bottom plate 7b therebetween. The lower surfaces of the planetary gears 12 are in contact with the annular protruding portion 7e. When the movable-side housing 3 rotates relative to the stationary-side housing 2, the planetary gears 12 meshing with the gears 8 and 11 may revolve while rotating on the annular protruding portion 7e. The number of the planetary gears 12 may not be limited to two. One or three or more planetary gears 12 may mesh with the gears 8 and 11.

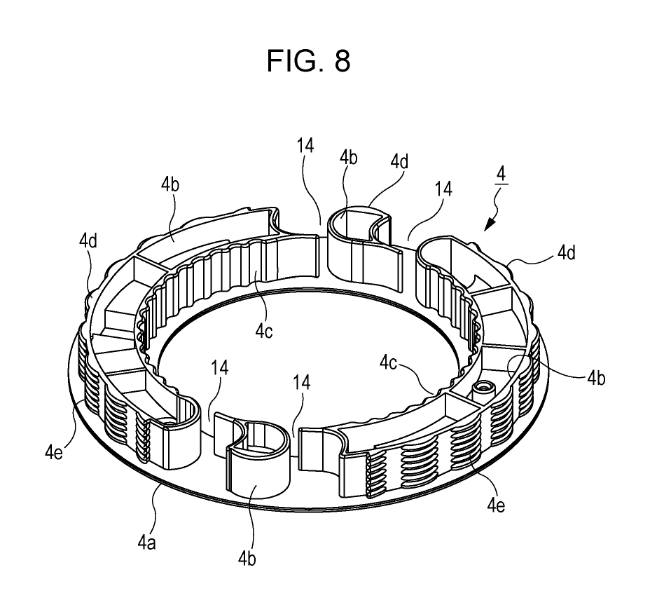

A movable body 4 molded of synthetic resin and a plurality of flat cables 5 may be housed within the housing space S. As shown in FIG. 8, the movable body 4 may include a ring-like flat plate portion 4a and a plurality of restricting walls 4b erected on the flat plate portion 4a. The above-described planetary gears 12 may be rotatably supported on the lower surface of the flat plate portion 4a. When the planetary gears 12 rotate and revolve, along with this the movable body 4 may rotate within the housing space S. Openings 14 may be secured between four restricting walls 4b. In an exemplary embodiment, two restricting walls 4b whose length in the circumferential direction is sufficiently long and two restricting walls 4b whose length in the circumferential direction is very short compared to these two restricting walls 4b may be alternately erected on the flat plate portion 4a, and four openings 14 of the same size are provided between the restricting walls 4b. In the movable body 4, wall surfaces extending in the circumferential direction on the radially inner and outer sides of the four restricting walls 4b may be formed concentrically with the ring-like flat plate portion 4a of the movable body 4. When the movable body 4 is incorporated in the rotary connector 1, the center of the flat plate portion 4a of the movable body 4 may coincide with the center of the center hole 7a of the bottom plate 7b.

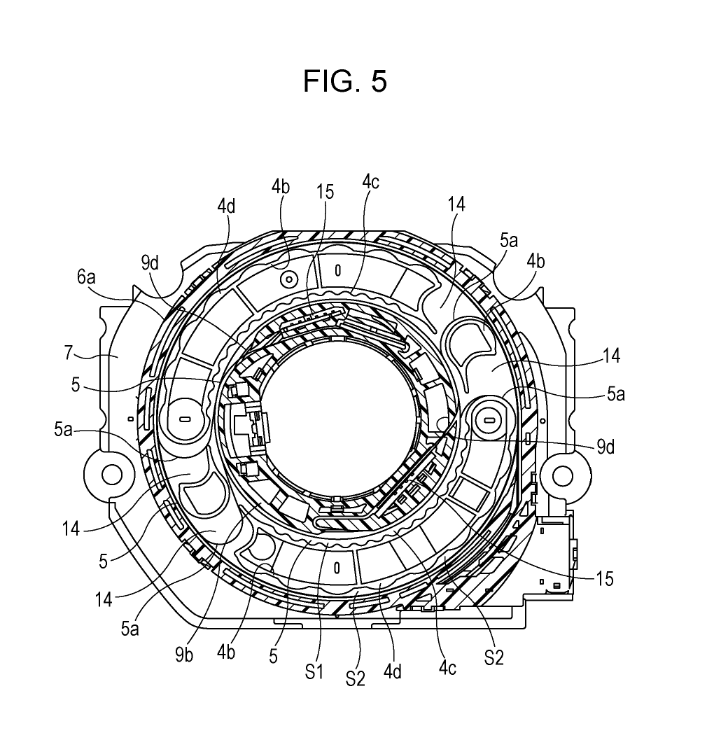

As shown in FIG. 5, a plurality of groove portions 4c may be formed in the inner peripheral wall surfaces (inner peripheral surfaces) of the longer two restricting walls 4b. The groove portions 4c have a U-shaped cross-section and may extend in a direction perpendicular to the plate surface of the flat plate portion 4a. By arranging the groove portions 4c in succession along the inner peripheral surfaces of the restricting walls 4b in such a manner that they form alternating recesses and protrusions, a gap S1 whose outer side is corrugated may be secured between the inner peripheral surfaces of the restricting walls 4b and the outer peripheral surface of the inner cylindrical body 9. That is, when the movable body 4 is seen from above (in plan view), the inner peripheral surfaces of the restricting walls 4b may have such a corrugated shape that recessed portions (recesses of the groove portions 4c) and protruding portions (portions between adjacent groove portions 4c) may be alternately arranged in the circumferential direction, and the bottoms of the recessed portions and the tops of the protruding portions are rounded smoothly.

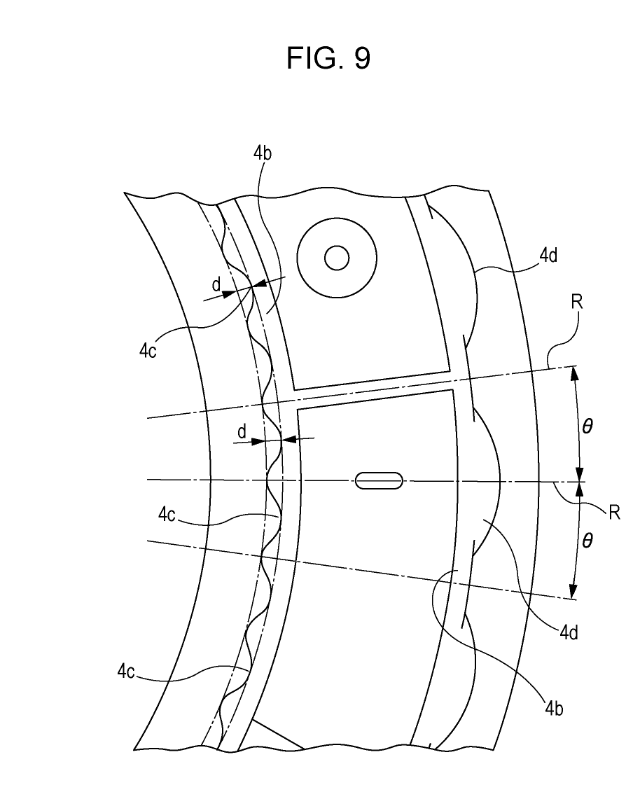

As shown in FIG. 9, let d be the depth of the groove portions 4c, and θ be the central angle corresponding to the length in the circumferential direction of the groove portions 4c (the angle between a pair of radial lines R extending from the center of the restricting walls 4b to the bottoms of adjacent groove portions 4c). The dimension d and the angle θ may be set within ranges of 0.5 mm≦d≦2.0 mm and 5 degrees≦θ≦30 degrees. Owing to such a configuration, the movable body 4 can be a single-piece component such as a resin molding, the structure can be simplified, the need for rollers can be eliminated, and the generation of noise can be suppressed. The friction coefficient between the inner peripheral surfaces of the restricting walls 4b and the flat cables 5 may be reduced, and the flat cables 5 can be smoothly withdrawn to the outer cylindrical body 6a side. The dimension d and the angle θ may be set within ranges of 0.5 mm≦d≦1.5 mm and 7.5 degrees≦θ≦15 degrees. In this case, the friction coefficient between the inner peripheral surfaces of the restricting walls 4b and the flat cables 5 may be further reduced. If lubricant such as grease adheres to the flat cables 5 and the restricting walls 4b, the flat cables 5 are less likely to adhere to the restricting walls 4b, therefore the flat cables 5 can be prevented from adhering to the restricting walls 4b, and when the flat cables 5 are withdrawn to the outer cylindrical body 6a side, the flat cables 5 can be prevented from buckling. If the dimension d is smaller than 0.5 mm, the friction coefficient between the movable body 4 and the flat cables 5 cannot be sufficiently reduced. If the dimension d is greater than 2.0 mm, the groove portions 4c are too deep, and a production problem of the difficulty of molding arises. If the angle ν is smaller than 5 degrees, the groove portions 4c are too fine, and it may be difficult to mold the movable body 4. If the angle θ is greater than 30 degrees, the groove portions 4c are too coarse, and the friction coefficient between the movable body 4 and the flat cables 5 cannot be sufficiently reduced. In the case of this exemplary embodiment, a plurality of groove portions 4c having a depth of 1 mm and a groove width the central angle corresponding to which is 7.5 degrees are formed in the inner peripheral surfaces of the two restricting walls 4b that are longer in the circumferential direction.

Of the four long and short restricting walls 4b erected on the flat plate portion 4a, the longer two restricting walls 4b may have a plurality of protruding portions 4d formed on the outer peripheral wall surfaces (outer peripheral surfaces) thereof. A gap S2 whose inner side is corrugated may be secured between the outer peripheral surfaces of the restricting walls 4b and the inner peripheral surface of the outer cylindrical body 6a. That is, when the movable body 4 is seen from above (in plan view), the outer peripheral surfaces of the restricting walls 4b may have such a corrugated shape that the protruding portions 4d and recessed portions may be alternately arranged (see FIG. 5), and the shape formed by connecting the tops of the protruding portions 4d may be a polygonal shape. In an exemplary embodiment, a total of 18 protruding portions 4d may be formed on the outer peripheral surface of the longer two restricting walls 4b, and therefore the shape formed by connecting the tops of the protruding portions 4d may be an octadecagonal shape. A plurality of grooves 4e (see FIG. 3) extending in the circumferential direction may be formed in the outer peripheral surface of each protruding portion 4d. The grooves 4e may be formed in such a manner that recesses and protrusions may be alternately arranged in the axial direction (see FIG. 8).

The flat cables 5 each may be a belt-like member including an insulating film made of PET or the like and conductors supported thereon. The flat cables used have thin (less elastic) insulating films (135 μm in thickness). The flat cables 5 may be housed within the housing space S in a state where the winding direction of each flat cable is reversed halfway. In this exemplary embodiment, four flat cables 5 may be housed together with the movable body 4 within the housing space S. As shown in FIG. 4, the outer ends of the flat cables 5 may be connected to joint portions 15 fixed to the outer cylindrical body 6a, and may be electrically led out to the outside through a cable lead-out portion 6d formed in the outer cylindrical body 6a (see FIG. 5). The inner ends of the flat cables 5 may be connected to joint portions 15, and may be electrically led out to the outside through a cable lead-out portion 9d formed in the inner cylindrical body 9b. As shown in FIG. 5, each flat cable 5 led out through the cable lead-out portion 9d to the gap S1 may be housed in the housing space S in such a manner that it is wound counterclockwise on the outer peripheral surface of the inner cylindrical body 9b within the gap S1, may be then reversed in a U-shape within the opening 14 of the movable body 4 (hereinafter this will be referred to as reversed portion 5a), may be withdrawn to the gap S2, may be wound clockwise on the inner peripheral surface of the outer cylindrical body 6a within the gap S2, and then may reache the joint portion 15 fixed to the outer cylindrical body 6a through the cable lead-out portion 6d.

The rotary connector 1 configured as above may be incorporated in a steering system in a backward tilted position as described above. As shown in FIG. 1, the stationary-side housing 2 may be fixed to the attachment surface of the steering column C in such a manner that the depressed portion 7h formed in the bottom plate 7b of the lower case 7 may face vertically downward. When the movable-side housing 3 may rotate in the forward or reverse direction integrally with the steering wheel H, according to the rotation direction each flat cable 5 may be withdrawn from the inner cylindrical body 9b and rewound on the outer cylindrical body 6a, or withdrawn from the outer cylindrical body 6a and rewound on the inner cylindrical body 9b, and each reversed portion 5a may move in the same direction by an amount of rotation smaller than that of the movable-side housing 3. At the same time, the sun gear 11 may rotate relative to the internal gear 8, therefore the planetary gears 12 meshing with the gears 8 and 11 rotate and revolve on the annular protruding portion 7e of the bottom plate 7b, and the movable body 4 rotatably supporting the planetary gears 12 may rotate within the housing space S. The gear ratio between the internal gear 8 and the sun gear 11 and the planetary gears 12 may be set so that the reversed portions 5a of the flat cables 5 and the openings 14 of the movable body 4 move at the same speed and in the same direction, and therefore the four flat cables 5 may be rewound or wound in a state where the radial movement is restricted by the restricting walls 4b of the movable body 4. Therefore, the airbag inflator and others on the steering wheel H side and the control portion on the steering column C side are always connected to each other by the flat cables 5 of the rotary connector 1 regardless of the steering angle (rotation angle) of the steering wheel H.

Under such conditions of use, a slight clearance may be secured between the sliding parts of the ring portion 6b of the stationary-side housing 2 and the top plate portion 9a of the movable-side housing 3. If foreign substances such as dust or hard sand enter the housing space S through this clearance, the foreign substances fall to the bottom plate 7b of the lower case 7 and, owing to the vibration of the vehicle or the like, may be accumulated in the depressed portion 7h through the first annular groove 7f located on the radially outer side of the annular protruding portion 7e provided on the bottom plate 7b. As shown in FIG. 7, the radially outer inner wall of the depressed portion 7h may be formed so as to be located radially outward from the lower end of the internal gear 8 provided on the stepped wall 7d of the lower case 7. Therefore, foreign substances entering the housing space S from the outside may be moved to and accumulated in a region of the depressed portion 7h located radially outward from the lower end of the internal gear 8. Therefore, the planetary gears 12 meshing with the internal gear 8 and the sun gear 11 are not caused to jam by foreign substances, particularly sand that is greater in grain diameter and harder than dust. With the rotation of the movable-side housing 3, the planetary gears 12 may rotate smoothly and drive the movable body 4. Therefore, the steering wheel H can be rotationally operated without being affected by foreign substances.

In addition, since the first annular groove 7f may be formed in a region between the outer peripheral wall surface of the annular protruding portion 7e and the internal gear 8, and a recessed portion is formed by both the first annular groove 7f and the depressed portion 7h, the region of the recessed portion in which foreign substances entering the housing space S can be accumulated is expanded, and the chance that the planetary gears 12 are caused to jam by foreign substances can be further reduced. Further, since the second annular groove 7g that is continuous along the circumferential direction is formed in a region of the bottom plate 7b between the inner peripheral wall surface of the annular protruding portion 7e and the sun gear 11, the region in which foreign substances can be accumulated may be expanded not only on the radially outer side of the annular protruding portion 7e but also on the radially inner side thereof. Therefore, if for some reason foreign substances entering the housing space S adhere to the surface of the annular protruding portion 7e, and the foreign substances are pushed to the radially inner side by the movement of the planetary gears 12 rotating and revolving on the annular protruding portion 7e, the foreign substances can be caused to fall into and accumulated in the second annular groove 7g before they reach the sun gear 11, and the fear that free rotational operation of the steering wheel H is prevented by foreign substances is further reduced.

As described above, in the rotary connector 1 according to an exemplary embodiment, a plurality of restricting walls 4b extending in the circumferential direction with openings 14 therebetween may be erected on a movable body 4 that may rotate within the housing space S with the rotation and revolution of the planetary gears 12, and the radial movement of the flat cables 5 may be restricted by passing the reversed portions 5a through the openings 14. Therefore, the movable body 4 can be integrally molded of synthetic resin, the structure can be simplified, the cost can be reduced, the need for rollers can be eliminated, and the generation of noise can be suppressed. A plurality of groove portions 4c may be formed in the inner peripheral surfaces of the restricting walls 4b so as to be continuous with one another along the circumferential direction, and the depth and groove width (length in the circumferential direction) of the groove portions 4c may be set as follows. This can prevent the flat cables 5 being rewound from adhering to the inner peripheral surfaces of the restricting walls 4b and preventing the rotation of the movable-side housing 3. That is, when the flat cables 5 wound on the inner cylindrical body 9b of the movable-side housing 3 are rewound on the outer cylindrical body 6a of the stationary-side housing 2 through the openings 14 of the movable body 4, the flat cables 5 withdrawn from the inner cylindrical body 9b head toward the openings 14 while touching the inner peripheral surfaces of the restricting walls 4b. If a plurality of groove portions 4c are formed in such contact parts so as to be continuous with one another along the circumferential direction, the friction coefficient between the inner peripheral surfaces of the restricting walls 4b and the flat cables may be reduced, and therefore the flat cables 5 can be smoothly withdrawn from the inner cylindrical body 9b side to the outer cylindrical body 6a side.

Specifically, the depth d of the groove portions 4c, and the central angle θ corresponding to the length in the circumferential direction of the groove portions 4c are set within ranges of 0.5 mm≦d≦2.0 mm and 5 degrees≦θ≦30 degrees. Therefore, the movable body 4 can be a single-piece component such as a resin molding, the structure can be simplified, the need for rollers can be eliminated, and the generation of noise can be suppressed. The friction coefficient between the inner peripheral surfaces of the restricting walls 4b and the flat cables 5 is reduced. Although less elastic flat cables 5 are used, the flat cables 5 can be smoothly withdrawn to the outer cylindrical body 6a side. The dimension d and the angle θ may be set within ranges of 0.5 mm≦d≦1.5 mm and 7.5 degrees≦θ≦15 degrees. In this case, the friction coefficient between the inner peripheral surfaces of the restricting walls 4b and the flat cables 5 may be further reduced. If lubricant such as grease adheres to the flat cables 5 and the restricting walls 4b, the flat cables 5 may be less likely to adhere to the restricting walls 4b, therefore the flat cables 5 can be prevented from adhering to the restricting walls 4b, and when the flat cables 5 are withdrawn to the outer cylindrical body 6a side, the flat cables 5 can be prevented from buckling.

A plurality of (four) flat cables 5 may be housed within the housing space S, and the movable body 4 may be provided with a plurality of (four) openings 14 through which the reversed portions 5a of the flat cables 5 pass separately. Therefore, a rotary connector 1 employing two or more flat cables 5 can be made. However, the number of openings 14 provided in the movable body 4 does not necessarily need to be equal to the number of flat cables 5 used. For example, if the movable body 4 is preliminarily provided with four openings 14, and only two of the four openings 14 are used as spaces for placing the reversed portions 5a, a rotary connector 1 having a different number of flat cables 5 can be made using a common movable body 4.

In the above-described exemplary embodiment, of the four restricting walls 4b erected on the movable body 4 and having different lengths in the circumferential direction, only the longer two restricting walls 4b have groove portions 4c formed in the inner peripheral surfaces thereof. However, groove portions 4c may be formed in the inner peripheral surfaces of all of the restricting walls 4b. In short, it is only necessary to form a plurality of groove portions 4c in the inner peripheral surfaces of the restricting walls 4b with potential to cause friction with the flat cables 5.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A rotary connector comprising:
a stationary-side housing having an outer cylindrical body;
a movable-side housing having an inner cylindrical body facing the outer cylindrical body and disposed concentrically with the stationary-side housing;
at least one flat cable housed within a housing space between the outer cylindrical body and the inner cylindrical body in a state where the winding direction of the at least one flat cable is reversed halfway, the at least one flat cable being fixed to the stationary-side housing at one end and to the movable-side housing at the other end; and
a movable body rotatably disposed within the housing space and having at least one opening through which the reversed portion of the at least one flat cable passes,
wherein a planetary gear rotatably supported by the movable body meshes with an internal gear provided in the stationary-side housing and a sun gear provided in the movable-side housing,
wherein restricting walls extending in the circumferential direction of the housing space with the at least one opening therebetween are erected on the movable body, and a plurality of groove portions are formed along the circumferential direction in the inner peripheral surfaces of the restricting walls facing the inner cylindrical body, and
wherein the depth d of the groove portions and the central angle θ corresponding to the length in the circumferential direction of the groove portions are set within ranges of 0.5 mm≦d≦2.0 mm and 5 degrees≦θ≦30 degrees.

2. The rotary connector according to claim 1, wherein the plurality of groove portions form a corrugated shape in which recesses and protrusions are alternately arranged in the circumferential direction of the restricting walls.

3. The rotary connector according to claim 1, wherein the at least one flat cable comprises a plurality of flat cables, the at least one opening comprises a plurality of openings, and the reversed portions of the plurality of flat cables separately pass through the plurality of openings.
